(19) United States
(12) Patent Application Publication
(10) Pub. No.: US 2010/0301588 A1
(43) Pub. Date: Dec. 2, 2010

(54) Airbag assembly

(75) Inventors: Tom Mogg, Shelby Township, MI (US); Jason Carl Lisseman, Shelby Township, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 12/457,100

(22) Filed: Jun. 1, 2009

(51) Int. Cl. B60R 21/16

(52) U.S. Cl. 280/728.2

(57) ABSTRACT

An airbag assembly for use within a vehicle, which includes an airbag; an inflator; and an airbag housing. The airbag housing includes a cavity for storing the airbag and is configured to be mounted in the vehicle. The cavity includes a plurality of fins, which are configured to direct inflation gas and to conduct heat from the inflation gas to the fins. The housing further includes a plurality of walls and a base that form a frame structure surrounding the cavity and an opening through which the airbag deploys into the vehicle. The airbag is configured to be deployed by inflation gas provided by the housing inflator, and configured to provide protection to an occupant. The inflator is mounted in and coupled to the housing.

### BACKGROUND

The present application relates generally to the field of vehicle airbags which provide occupant protection when deployed (e.g., during a dynamic vehicle impact event). More specifically, the application relates to an improved occupant protection system (or airbag) constructed with an improved housing for coupling to a motor vehicle.

Airbags are located in vehicles to protect occupants from injury during a vehicle dynamic impact event, which triggers sensors located in the vehicle to initiate deployment of airbags. An airbag may deploy and inflate, by gas rapidly entering the airbag; typically through the use of an inflator containing an explosive charge (e.g., pyrotechnic device). Passenger airbags are typically stored within a housing attached to a portion of the vehicle and are typically packaged through a process of folding and rolling to compact the airbag in order to minimize its required packaging space. During a vehicle dynamic impact event, a passenger airbag may deploy from the upper portion (i.e., above the glove box) of the dashboard, in substantially rearward and upward directions to protect the torso and head of the occupant, while the knee airbag deploys, typically from the lower portion (i.e., below the glove box) of the dashboard, in substantially rearward and downward directions to protect the knees and legs of the occupant. Driver side airbags are typically stored within the steering column and deploy substantially rearward toward the occupant.

It has been known to make an airbag housing from steel, which has several disadvantages. First, steel airbag housings have a relatively high mass and weight relative to other airbag housing configurations. Although the steel housings are made having thinner wall thicknesses relative to other airbag housing configurations, the high density of steel still creates a heavy airbag housing. Second, the geometry of steel airbag housings are limited by the method of manufacture, which typically is stamping through a progressive die set. To incorporate additional features into a steel airbag housing requires the coupling of other components through fastening or welding, which is expensive and further increases mass. A conventional airbag housing 340 made from steel is shown in FIG. 4. The conventional airbag housing 340 is substantially rectangular, having a hat-shaped cross section, as shown in FIG. 5. The base of the airbag housing includes a semi-circular portion for retaining a cylindrical inflator.

It has also been known to construct an airbag housing from a plastic material, which has several disadvantages. First, plastic airbag housings have a similar geometry to that illustrated in FIG. 4, except due to the molding process require a draft angle. The draft angle dictates that a relatively thick wall be used, so although the density of plastic is significantly less than steel, the increased wall thickness increases the mass of the housing. The strength of the housing is designed for the thinnest section, so the increasing thickness required by the draft angle generates wasted material. Second, plastic airbag housings have a glass transition temperature where the polymer transitions from a solid to a flowing semi-solid material. Thus, the high temperatures created by the gas generator may exceed the glass transition temperature, causing damage or melting the housing.

### SUMMARY

This application relates to an airbag assembly for use within a vehicle, which includes an airbag; an inflator; and an airbag housing. The airbag is configured to be deployed by inflation gas provided by the housing inflator, and configured to provide protection to an occupant. The inflator is mounted in and coupled to the housing. The airbag housing includes a cavity, made from magnesium using a thixomolding process, for storing the airbag and is configured to be mounted in the vehicle. The cavity includes a plurality of fins, which are configured to direct inflation gas and to conduct heat from the inflation gas to the fins. The housing further includes a plurality of walls and a base that form a frame structure surrounding the cavity and an opening through which the airbag deploys into the vehicle. The housing further includes a vent and a corresponding vent gate, wherein the vent gate is configured to be displaced by a displacing member, comprising a micro-gas generator, from a first position to a second position. The first position of the vent gate allows inflation gas to pass through the vent of the housing and the second position of the vent gate covers at least part of the vent of the housing, prohibiting at least a portion of the inflation gas from passing through the vent. The inflation gas that passes through the vent of the housing inflates an inflatable protection device other than the airbag.

### BRIEF DESCRIPTION OF THE DRAWINGS

FIG. 1 is a is a perspective view of a motor vehicle.

FIG. 2 is a perspective view of an exemplary embodiment of a portion of an interior passenger compartment of a motor vehicle, such as the motor vehicle of FIG. 1.

FIG. 3 is a cross-car section view of an interior passenger compartment, such as the passenger compartment of FIG. 2, illustrating an airbag folded within an airbag housing.

FIG. 4 is a perspective view of a conventional embodiment of an airbag folded within an airbag housing.

FIG. 5 is a cross-section view of the conventional embodiment of the airbag housing of FIG. 4.

FIG. 6 is a side view of an exemplary embodiment of an airbag assembly for use within a vehicle, such as the vehicle of FIG. 1.

FIG. 7 is a top view of the airbag assembly of FIG. 6.

FIG. 8 is a cross section view of the airbag assembly of FIG. 7 taken along line 8-8.

FIG. 9 is a detail view of the airbag assembly of FIG. 6, showing an exemplary embodiment of a vent gate in the open position.

FIG. 10 is a detail view of the airbag assembly of FIG. 6, showing an exemplary embodiment of a vent gate in the closed position.

FIG. 11 is a perspective view of an exemplary embodiment of an airbag housing for use in an airbag assembly, such as the airbag assembly of FIG. 6.

FIG. 12 is a side view of the airbag housing of FIG. 11.

FIG. 13 is a front view of the airbag housing of FIG. 11.

FIG. 14 is a bottom view of the airbag housing of FIG. 11.

FIG. 15 is an exemplary embodiment of a cavity of an airbag housing, such as the airbag housing of FIG. 11.

FIG. 16 is a detail view of the cavity of the airbag housing of FIG. 15.

### DETAILED DESCRIPTION

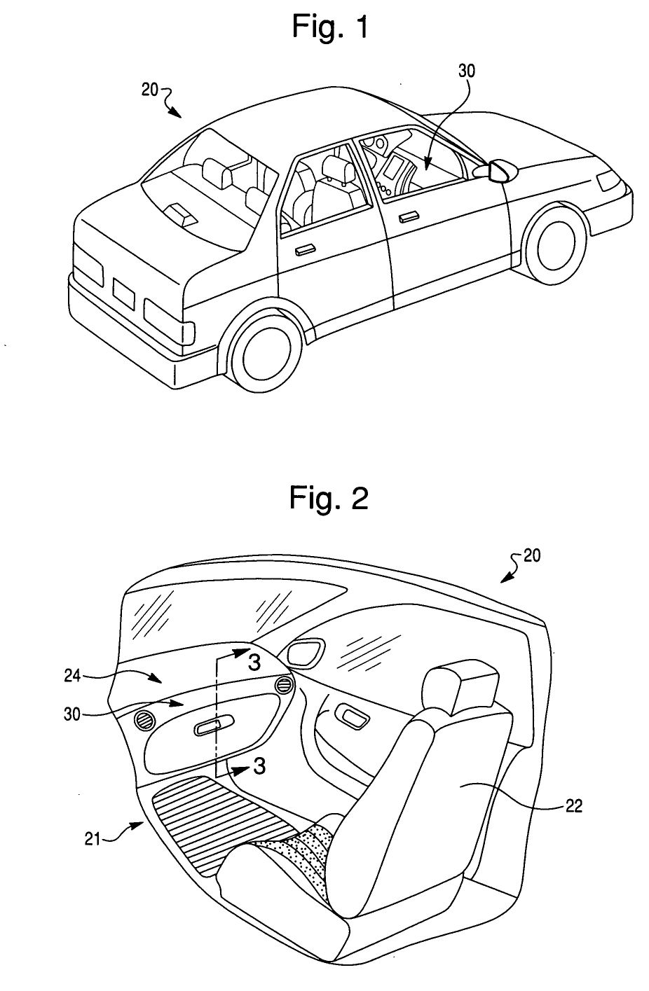

Referring to FIG. 1, an exemplary embodiment of a motor vehicle 20 is illustrated, and includes an airbag assembly 30. The vehicle 20 is illustrated as a typical sedan, but an airbag system as disclosed in this application may be used on any type of passenger vehicle as well as other moving vehicles that offer occupant protection to seated passengers in the form of inflatable safety systems which include an airbag assembly or an inflatable protection device.

Referring to FIG. 2, an exemplary embodiment of a passenger compartment 21 of the vehicle 20 of FIG. 1, is illustrated, and includes a dashboard assembly 24, and a passenger seat assembly 22. According to another exemplary embodiment, dashboard assembly 24 includes an airbag assembly 30 integrated within it, and may be configured to fit within the unique packaging requirements of vehicle 20. According to other embodiments, airbag assembly 30 may be configured within a glove box assembly or within other useful components of vehicle 20. Airbag assembly 30 is flexibly configurable for use in varying package requirements, and may be tailored to satisfy specific needs of the vehicle manufacturer. It should be noted that although FIG. 2 illustrates a passenger compartment, the embodiments disclosed in this application are configurable for driver side airbag assemblies, side curtain airbag assemblies, or any inflatable protection device for any vehicle.

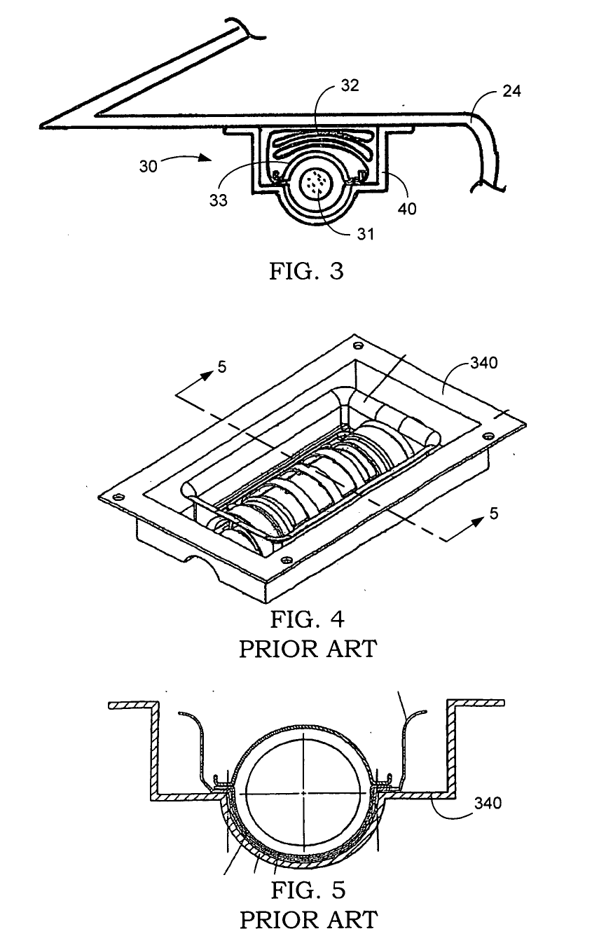

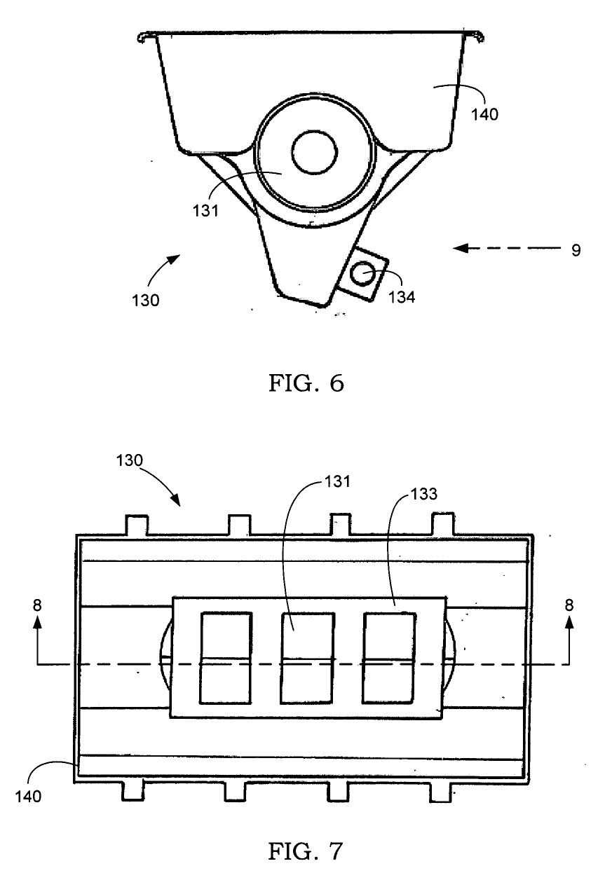

Referring to FIG. 3, an exemplary embodiment of an airbag assembly 30 is illustrated, and includes an inflator (or gas generator) 31, an airbag 32, a diffuser 33, and a housing 40. Airbag assembly 30 may be configured to be coupled to the dashboard 24, so that airbag 32 breaches the substantially horizontal portion of the dashboard during deployment, and unfolds initially in the vertical direction then in the horizontal direction toward the occupant. According to another embodiment, airbag assembly 30 may be configured to breach a substantially vertical portion of the dashboard 24, so that the airbag 32 deploys and unfolds in a substantially horizontal direction toward the occupant. According to other embodiments, airbag assembly 30 may be configured within other components, such that airbag 32 deploys and unfolds in any useful direction.

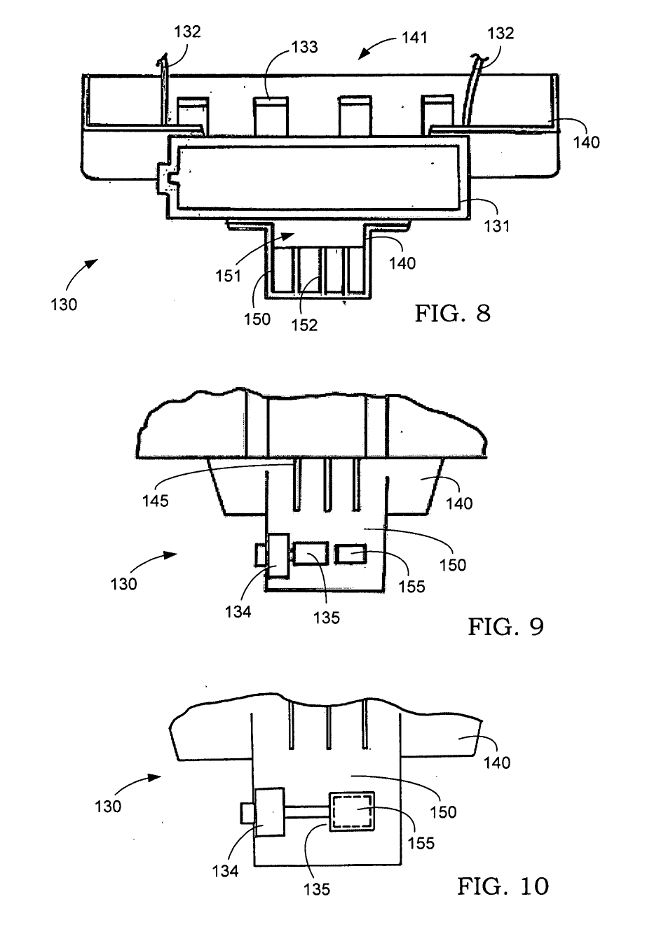

Referring to FIGS. 6-8, an exemplary embodiment of an airbag assembly 130 is illustrated and includes an inflator 131, an airbag 132, a diffuser 133, micro-gas generator (MGG) 134, a vent gate 135, and a housing 140. According to an exemplary embodiment, inflator 131 is a single stage tubular shaped inflator, which provides inflation gas to expand and unfold airbag 132 during activation and deployment. Inflator 131 may be coupled to the housing 140 using any suitable fastener or any suitable coupling method. According to other embodiments, inflator 131 may be dual stage and may be coupled to other members of airbag assembly 130. Inflator 131 includes a plurality of gas ports, through which gas is forced out of during gas generation. According to an exemplary embodiment, diffuser 133 may be configured in a semi-circular shape having a plurality of slots or openings, which allow inflation gas to pass through. Diffuser 133 may be coupled to the housing 140 and may direct inflation gas entering airbag 132 to aid in deployment of airbag 132.

According to an exemplary embodiment, vent gate 135 is a substantially rectangular shaped plate, which is coupled to a displacing member, as shown in FIG. 9. The displacing member provides for. According to other embodiments, vent gate 135 may be round, elliptical, or any useful shape, as it is configured to cover the shape of the vent 155 of the cavity 150 of housing 140. MGG 134 may be a pyrotechnic device, and may provide displacement of vent gate 135 when triggered or activated. According to an exemplary embodiment, MGG 134 is coupled directly to the cavity 150 of housing 140. The MGG may be coupled to other components of the airbag assembly.

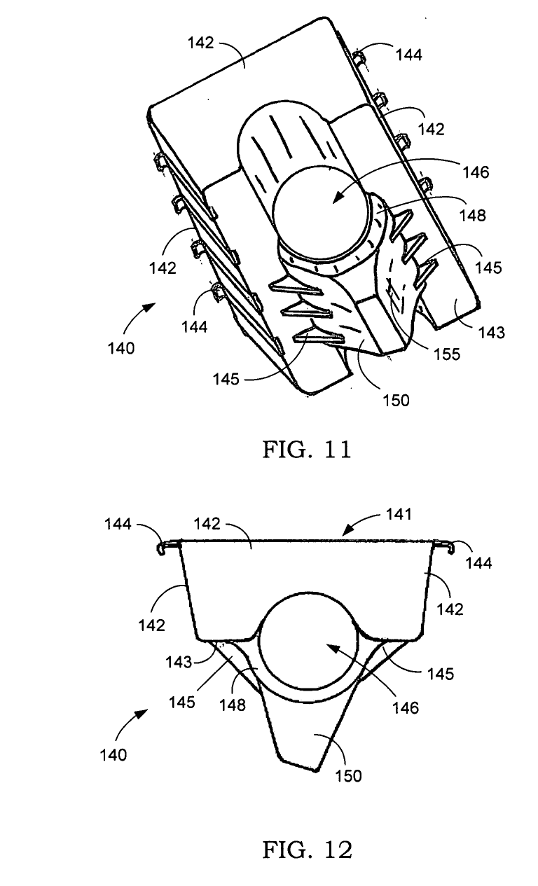

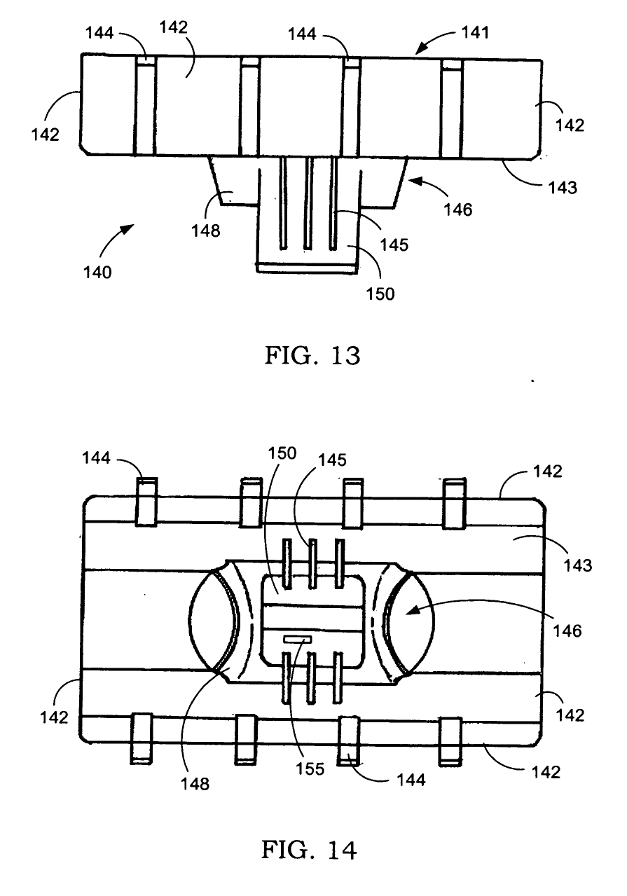

Referring to FIGS. 11-14, an exemplary embodiment of a housing 140 is illustrated. According to an exemplary embodiment, housing 140 may be made from magnesium (e.g., AZ91, AM50A, AM60B, AE42), through an injection molding process, such as thixomolding. The magnesium may be injected into a mold in a semi-solid state under high temperature and pressure to form housing 140. This process allows for a housing 140 to be low mass, high strength, and to incorporate complex geometry to improve the performance of the airbag assembly 130. The magnesium housing 140 may be low mass relative to conventional steel housings, since the magnesium can have one-quarter the density of 1008/1010 steel with a comparable strength (e.g., yield strength, tensile strength). This process of injection molding a semi-solid magnesium at high pressure and temperature also significantly reduces porosity, which substantially reduces strength and is symptomatic of conventional die casting liquid magnesium. Magnesium housings may be low mass relative to conventional plastic or polymer housings, since the injected molded magnesium can be made with no draft angle. A polymer housing requires the use of draft angles during molding. The draft angle adds thickness and mass without improving the overall strength of the housing because the housing must be designed so that the thinnest wall section is designed to accommodate the strength requirements of the housing. On the other hand, the magnesium housing 140 may be mass to strength optimized, because there is no draft angle required. Furthermore, the magnesium housing 140 may be high strength relative to a conventional plastic housing, and may have strength comparable to a conventional steel housing.

According to an exemplary embodiment, housing 140 is substantially box shaped, and includes an opening 141, four walls 142, and a base 143. According to other embodiments, housing 140 may include any number of walls 142 and may take any useful shape (e.g., elliptical, cylinder). The four walls 142 are substantially rectangular shaped and configured substantially vertical to form the box shaped frame structure of housing 140. The walls 142 may be substantially flat or may have formed or embossed portions, and may be made having relative thin thickness, due to the material and molding process and the ability to not include a draft angle. According to an exemplary embodiment, the side walls include hooks 144, which can couple the housing 140 to another component of airbag assembly 130 or directly to the vehicle 20. According to other embodiments, housing 140 may include a lip or overhang portion that can be coupled to another component, or may provide for coupling by any suitable fastener.

The base 143 forms the bottom portion of housing 140, and according to an exemplary embodiment, includes a semi-circular portion 148 with a round aperture 146 at each end. This configuration of apertures 146 and semi-circular portion 148 provides for coupling and retention of inflator 131, and may also provide for coupling and retention of other components, such as diffuser 133. Base 143 also includes a cavity 150, which extends downward from the semi-circular portion 148. According to an exemplary embodiment, cavity 150 is substantially triangular shaped and extends for a length not greater than the length of the semi-circular portion 148. According to other embodiments, cavity 150 may be substantially rectangular or may be any useful shape, and may extend the full length of the semi-circular portion 148 or any length less than the semi-circular portion 148. Cavity 150 includes a vent 155, which according to an exemplary embodiment, is a rectangular shaped aperture. According to other embodiments, vent 155 may be round, elliptical, or any useful shape. Cavity 150 may also include more than one vent 155.

According to an exemplary embodiment, opening 141 is formed by the tops of walls 142, which extend upwards from the base 143, coming together having a substantially rectangular shaped void. Opening 141 provides for easy assembly of components to the housing 140 and provides volume for the folded airbag 132 to reside prior to deployment. According to other embodiments, the opening may take other shapes and be tailored to meet specific applications.

According to an exemplary embodiment, housing 140 further includes a plurality of ribs 145 which may be used to provide improved strength or stability. Ribs 145 may be formed on the walls 142, on the base 143, and according to an exemplary embodiment, extend from the base 143 to the cavity 150 and connect to the semi-circular portion 148. It should be noted that the housing is not limited to the quantity or the position of the ribs as shown, as the ribs may be tailored to specific applications.

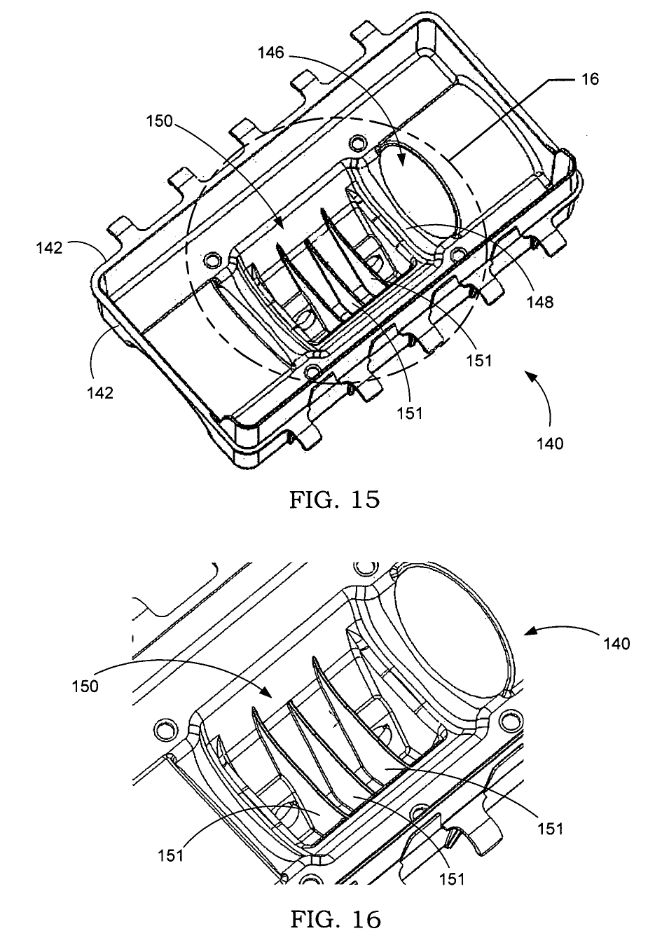

Referring to FIGS. 15 and 16, the cavity 150 of housing 140 is illustrated according to an exemplary embodiment. Cavity 150 includes a plurality of fins 151, which may extend parallel, perpendicular, or diagonal relative to-the walls 142. The use of magnesium for housing 140 allows fins 151 to be included with little cost impact and without the issues inherent to other materials. The fins 151 may direct the flow of inflation gas while acting as a heat sink to reduce the temperature of the inflation gas. Plastic or polymer housings could be damaged (e.g., melt or deform) due to the high temperature of the inflation gas generated by the inflator may exceed the glass transition temperature of the polymer housing, thereby transitioning the portions exposed to the high temperatures to a semi-solid state that can flow. Furthermore, steel housings cannot include fins because steel housings are made using a process of progressive stamping and the fabrication of fins is prohibited by cost constraints. Forming fins in a steel housing would require a significant and unacceptable cost increase. The fins 151 provide a heat sink by reducing the temperature of the inflation gas by convection, then by conducting the heat through the housing. This reduction of inflation gas temperature also helps to prevent damage to the airbag 132 itself, which typically is made from fabric. The fins 151 may further direct the flow of inflation gas as required throughout housing 140 to aid in deployment of airbag 32 of airbag assembly 30.

The inclusion of fins is not limited to the cavity area, as fins could also be formed in other portions of the housing. Also, the configuration of fins is not limited by the configuration shown in FIG. 10. The configuration of fins may be tailored to meet specific applications, such as, for example, differing airbag module designs associated with different vehicle platforms.

According to an exemplary embodiment, vent gate 135 is configured to have a first position, as shown in FIG. 9, and a second position, as shown in FIG. 10. In its first position (or open position), vent gate 135 is configured to not cover the vent 155 of housing 140, whereby inflation gas would be allowed to escape through vent 155. According to an exemplary embodiment, vent gate 135 occupies its first position prior to firing or actuation of MGG 134. In its second position (or closed position), vent gate 135 is configured to cover the vent 155 of housing 140 to prohibit inflation gas from escaping through vent 155. According to an exemplary embodiment, the firing or actuation of MGG 134 displaces the vent gate 135 into its second position to cover the vent 155. The vent gate 135 maintains this second position throughout deployment of airbag 32.

Airbag assembly 30 is configured to unfold airbag 32 with a tailored deployment based on the severity of the dynamic impact event of vehicle 20. During a low severity vehicle dynamic impact event, MGG 134 may not be fired, allowing some of the inflation gas to pass through vent 155 of housing 140 thereby reducing the volume of inflation gas deploying airbag 32, which deploys airbag 32 with a lower relative force to protect the occupant. During a high severity vehicle dynamic impact event, MGG 134 may be fired, displacing the vent gate 135 from its first position to its second position to cover the vent 155 of housing 140, which prohibits inflation gas from escaping through vent 155. The inflation gas being prohibited from escaping vent 155 is redirected upward by fins 151 (or other features of housing 140) through housing 140 and into airbag 32 thereby increasing the volume of inflation gas deploying airbag 32, which deploys airbag 32 with a higher relative force to protect the occupant.

According to another exemplary embodiment, the second position (or closed position) of vent gate 135, as shown in FIG. 10, is its position prior to the firing or actuation of MGG 134, and its first position (or open position), as shown in FIG. 9, is its position following firing or actuation of MGG 134. This embodiment is configured such that during a low severity vehicle dynamic impact event, MGG 134 may be fired, which displaces the vent gate 135 away form covering vent 155, thus allowing inflation gas to escape through vent 155 of housing 140. This embodiment is also configured such that during a high severity vehicle dynamic impact event, MGG 134 may not fire and vent gate 135 remains covering vent 155, which prohibits inflation gas from escaping through vent 155. Therefore, the firing of MGG 134 displaces the vent gate 135 from its second position to its first position for this embodiment.

According to another exemplary embodiment, vent gate 135 may have a closed position which only covers a portion of vent 155. Vent gate 135, for this configuration, may have a first position that does not cover any portion of vent 155, allowing inflation gas to pass through the entire cross section of vent 155; and may have a second position that is varied and covers a preset portion of vent 155, allowing some variable amount of inflation gas less than its first position allows to pass through vent 155. This embodiment may tailor the amount of inflation gas allowed to escape based on the crash severity and provide more than a binary response to the crash parameters.

It should be noted that the inflation gas that escapes through the vent of the housing may be used to inflate another airbag, such as a passenger knee airbag. The inflation gas that escapes through the vent of the housing may not be used to inflate another airbag and may be directed away from any occupants.

The use of the MGG to control whether inflation gas is allowed to escape through a vent allows the airbag assembly to be tailored for the severity of the crash, and allows the airbag assembly to be configured with a single stage inflator. A dual stage inflator is used to provide a relative increase in gas generation, through a first and a second stage, for relative high severity dynamic vehicle impact events, and to provide less gas generation, through only a first stage, for relative low severity dynamic vehicle impact events. This tailoring provides improved occupant protection, and the embodiments disclosed achieve this optimized occupant protection through the use of a single stage inflator. This reduces cost and mass of the airbag assembly and coupled with the mass reduction by using the magnesium airbag housing, the airbag assembly has a mass much lower relative to current airbag assemblies. According to other embodiments, the MGG may be replaced with other known devices that provide displacement in a relative short amount of time, as required during a vehicle dynamic impact event.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the airbag housings as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An airbag assembly for use within a vehicle, comprising:
an airbag;
an inflator;
an airbag housing including a cavity for storing the airbag; wherein the housing is configured to be mounted in the vehicle;
wherein the airbag is configured to be deployed by inflation gas provided by the housing inflator, and configured to provide protection to an occupant;
wherein the housing includes a plurality of walls and a base that form a frame structure surrounding the cavity and including an opening through which the airbag deploys into the vehicle;
wherein the inflator is mounted in and coupled to the housing; and
wherein the cavity includes a plurality of fins, which are configured to direct inflation gas and to conduct heat from the inflation gas to the fins.

2. The airbag assembly of claim 1, wherein the cavity of the housing is made from magnesium using a thixomolding process.

3. The airbag assembly of claim 1, wherein the housing includes a vent and a corresponding vent gate, wherein the vent gate is configured to be displaced by a displacing member from a first position to a second position.

4. The airbag assembly of claim 3, wherein the displacing member comprises a micro-gas generator.

5. The airbag assembly of claim 3, wherein the first position of the vent gate allows inflation gas to pass through the vent of the housing and the second position of the vent gate covers at least part of the vent of the housing, prohibiting at least a portion of the inflation gas from passing through the vent.

6. The airbag assembly of claim 3, wherein the inflation gas that passes through the vent of the housing inflates an inflatable protection device other than the airbag.

7. An airbag assembly for use within a vehicle, comprising:
an airbag;
an inflator;
an airbag housing including a cavity for storing the airbag; wherein the housing is configured to be mounted in the vehicle;
wherein the airbag is configured to be deployed by inflation gas provided by the housing inflator, and configured to provide protection to an occupant;
wherein the housing includes a plurality of walls and a base that form a frame structure surrounding the cavity and including an opening through which the airbag deploys into the vehicle;
wherein the inflator is mounted in and coupled to the housing; and
wherein the housing further includes a vent and a corresponding vent gate, wherein the vent gate is configured to be displaced by a displacing member from a first position to a second position.

8. The airbag assembly of claim 7, wherein the displacing member comprises a micro-gas generator.

9. The airbag assembly of claim 7, wherein the first position of the vent gate allows inflation gas to pass through the vent of the housing and the second position of the vent gate covers at least part of the vent of the housing, prohibiting at least a portion of the inflation gas from passing through the vent.

10. The airbag assembly of claim 7, wherein the inflation gas that passes through the vent of the housing inflates an inflatable protection device other than the airbag.

11. The airbag assembly of claim 7, wherein the housing is made from glass fiber reinforced polymer using a molding process.

12. The airbag assembly of claim 7, wherein the housing is made from magnesium using a thixomolding process.
